(19) United States
(12) Patent Application Publication
(10) Pub. No.: US 2025/0192340 A1
(43) Pub. Date: Jun. 12, 2025

(54) CROSS-MEMBER ASSEMBLIES WITH THERMAL MANAGEMENT VALVES FOR CONTROLLING BATTERY VENT BYPRODUCTS WITHIN TRACTION BATTERY PACKS

(71) Applicant: FORD GLOBAL TECHNOLOGIES, LLC, Dearborn, MI (US)

(72) Inventors: Patrick Roxin, Livonia, MI (US); Mohammadreza Eftekhari, Novi, MI (US); Kanchana Perumalla, Troy, MI (US); Douglas Christian Lipp, Ann Arbor, MI (US); Bhaskara Rao Boddakayala, Troy, MI (US)

(21) Appl. No.: 18/742,441

(22) Filed: Jun. 13, 2024

Related U.S. Application Data
(60) Provisional application No. 63/607,888, filed on Dec. 8, 2023.

(51) Int. Cl. H01M 50/342; H01M 10/653; H01M 50/227; H01M 50/233; H01M 50/249; H01M 50/262

(52) U.S. Cl. CPC H01M 50/342; H01M 10/653; H01M 50/227; H01M 50/233; H01M 50/249; H01M 50/262; H01M 2200/10; H01M 2200/20

(57) ABSTRACT

Battery cell stack cross-member assemblies are provided for traction battery packs. An exemplary cross-member assembly may include a thermally insulating sheet for blocking the transfer of thermal energy to adjacent structures inside the traction battery pack. The thermally insulating sheet incorporates thermal control valves in the form of movable flaps for controlling the flow of battery cell vent byproducts during battery thermal events.

### CROSS-REFERENCE TO RELATED APPLICATIONS

This disclosure claims priority to U.S. Provisional Application No. 63/607,888, which was filed on Dec. 8, 2023 and is incorporated herein by reference in its entirety.

### TECHNICAL FIELD

This disclosure relates generally to traction battery packs, and more particularly to cross-member assemblies that include integrated thermal management valves for controlling the flow of battery cell vent byproducts within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a cell stack including a plurality of battery cells arranged between a first cross-member assembly and a second cross-member assembly. The first cross-member assembly and the second cross-member assembly each include a ladder frame and a thermally insulating sheet mounted to the ladder frame.

In a further non-limiting embodiment of the foregoing traction battery pack, the ladder frame is made of a thermoplastic material and includes a plurality of cell tab openings, with each cell tab opening being sized to receive a terminal of one or more of the plurality of battery cells.

In a further non-limiting embodiment of either of the foregoing traction battery packs, the ladder frame includes a vent opening.

In a further non-limiting embodiment of any of the foregoing traction battery packs, the thermally insulating sheet includes a flap that is movable between a first position that covers the vent opening and a second position that uncovers the vent opening in response to a flow of a battery cell vent byproduct against the flap.

In a further non-limiting embodiment of any of the foregoing traction battery packs, the flap is movably connected to a membrane of the thermally insulating sheet by at least one bridge.

In a further non-limiting embodiment of any of the foregoing traction battery packs, the ladder frame includes a stake that is received through a mounting hole of the membrane to position the membrane relative to the ladder frame.

In a further non-limiting embodiment of any of the foregoing traction battery packs, the ladder frame includes a clip that holds the membrane relative to the ladder frame.

In a further non-limiting embodiment of any of the foregoing traction battery packs, the flap is held in the first position by a pressure sensitive adhesive.

In a further non-limiting embodiment of any of the foregoing traction battery packs, the pressure sensitive adhesive is configured to melt when a temperature of the battery cell vent byproduct exceeds a predefined temperature threshold to allow the flap to move to the second position.

In a further non-limiting embodiment of any of the foregoing traction battery packs, the ladder frame includes an integrally formed fastener housing.

In a further non-limiting embodiment of any of the foregoing traction battery packs, a fastener insert is received within the integrally formed fastener housing and is configured to receive a fastener.

In a further non-limiting embodiment of any of the foregoing traction battery packs, a pultruded reinforcement beam is attached to the ladder frame.

A traction battery pack according to another exemplary aspect of the present disclosure includes, among other things, a cross-member assembly including a ladder frame, a first reinforcement beam mounted to the ladder frame, a second reinforcement beam mounted to the ladder frame, and a thermally insulating sheet mounted to the ladder frame and including a membrane and a plurality of flaps movably connected to the membrane.

In a further non-limiting embodiment of the foregoing traction battery pack, the first reinforcement beam establishes a first pultrusion of the cross-member assembly, and the second reinforcement beam establishes a second pultrusion of the cross-member assembly.

In a further non-limiting embodiment of either of the foregoing traction battery packs, the first reinforcement beam establishes an upper plateau of the cross-member assembly, and the second reinforcement beam establishes a lower base of the cross-member assembly.

In a further non-limiting embodiment of any of the foregoing traction battery packs, an adhesive is applied to the upper plateau and to the lower base.

In a further non-limiting embodiment of any of the foregoing traction battery packs, a first fastener insert is received within a first fastener housing of the ladder frame, and a second fastener insert is received within a second fastener housing of the ladder frame.

In a further non-limiting embodiment of any of the foregoing traction battery packs, each of the plurality of flaps is movable between a first position that covers a respective vent opening of the ladder frame and a second position that uncovers the respective vent opening in response to a flow of a battery cell vent byproduct against the thermally insulating sheet.

In a further non-limiting embodiment of any of the foregoing traction battery packs, the ladder frame includes a stake that is received through a mounting hole of the membrane to position the membrane relative to the ladder frame.

In a further non-limiting embodiment of any of the foregoing traction battery packs, the ladder frame includes a clip that engages a notch of the membrane to secure the membrane relative to the ladder frame.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 illustrates an exemplary cell stack of the traction battery pack of FIG. 2.

FIG. 4 is a partial exploded view of the cell stack of FIG. 3.

FIG. 5 illustrates a first side of a thermally insulating sheet of a cross-member assembly of the cell stack of FIGS. 3 and 4.

FIG. 6 illustrates a second side of the thermally insulating sheet of FIG. 5.

FIG. 7 illustrates a thermally insulating sheet of a cross-member assembly during normal battery operating conditions.

FIG. 8 illustrates the thermally insulating sheet of FIG. 7 during a battery thermal event.

### DETAILED DESCRIPTION

This disclosure details battery cell stack cross-member assemblies for traction battery packs. An exemplary cross-member assembly may include a thermally insulating sheet for blocking the transfer of thermal energy to adjacent structures inside the traction battery pack. The thermally insulating sheet incorporates thermal control valves in the form of movable flaps for controlling the flow of battery cell vent byproducts during battery thermal events. These and other features are discussed in greater detail in the following paragraphs of this detailed description.

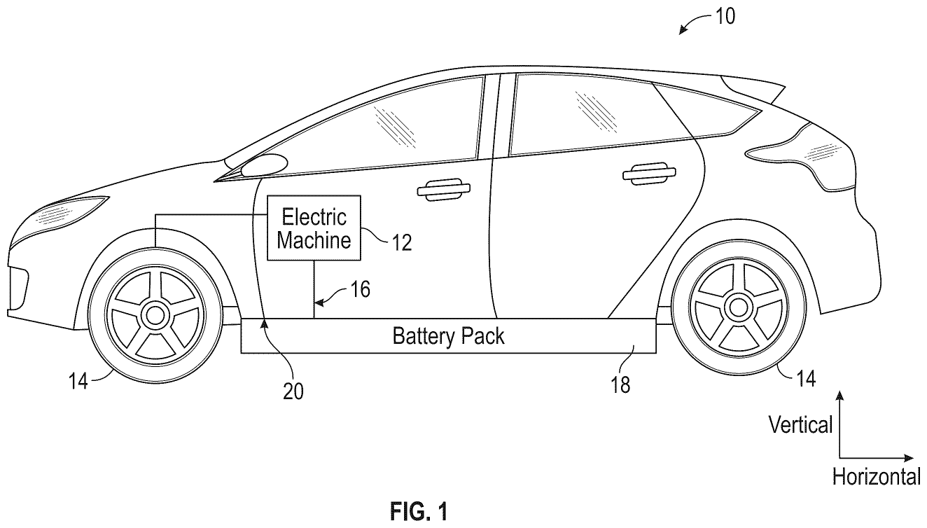

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

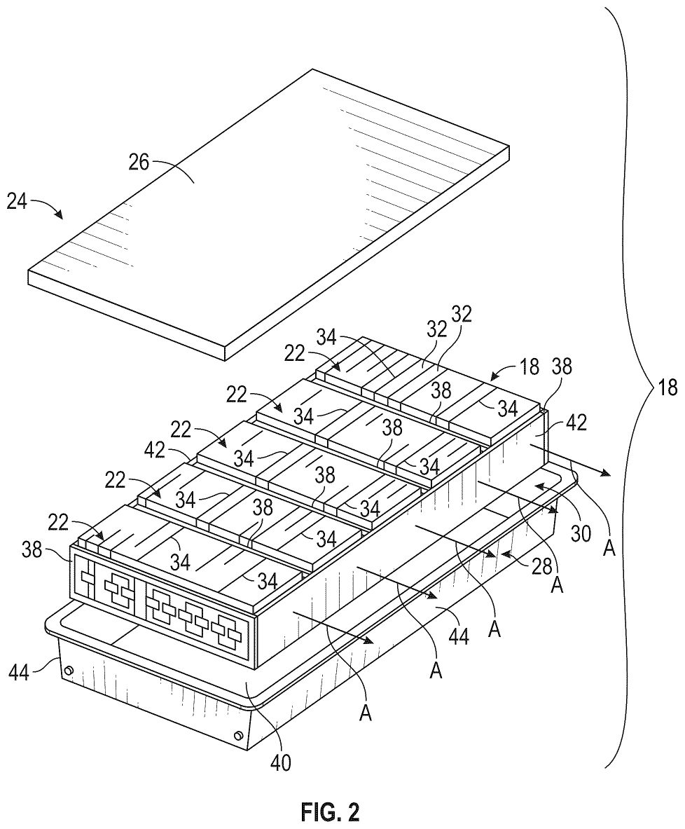

FIG. 2 illustrates additional details associated with the traction battery pack 18 of the electrified vehicle 10 of FIG. 1. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked together and arranged along a cell stack axis A. The battery cells 32 store and supply electrical power for powering various components of the electrified vehicle 10. Although a specific number of cell stacks 22 and battery cells 32 are illustrated in the various figures of this disclosure, the traction battery pack 18 could include any number of the cell stacks 22, with each cell stack 22 including any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The battery cells 32 can each include tab terminals that project outwardly from a battery cell housing. The tab terminals of the battery cells 32 of each cell stack 22 are connected to one another, such as by one or more busbars, for example, in order to provide the voltage and power levels necessary for achieving electric vehicle propulsion.

One or more thermal barrier assemblies 34 may be arranged along the respective cell stack axis A of each cell stack 22. The thermal barrier assemblies 34 may compartmentalize each cell stack 22 into two or more groupings or compartments of battery cells 32. Each compartment may hold one or more of the battery cells 32 of the cell stack 22.

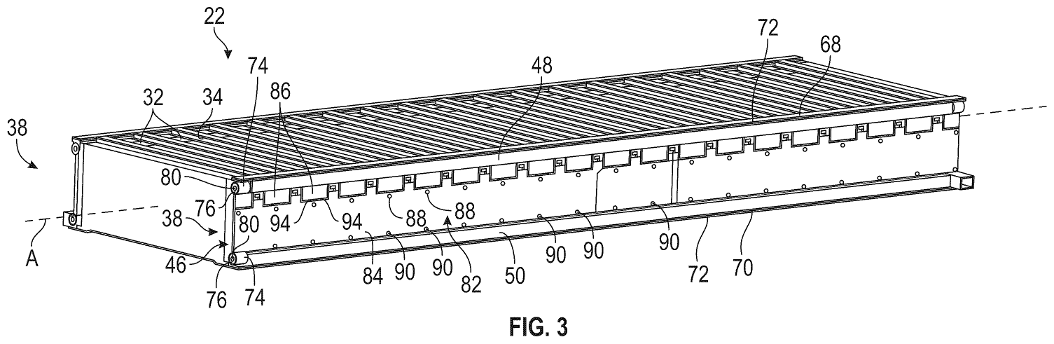

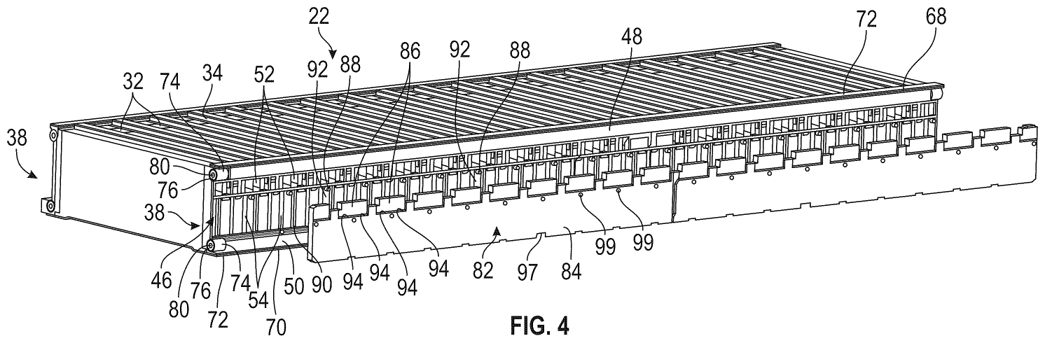

FIGS. 3 and 4, with continued reference to FIG. 2, illustrate one of the cell stacks 22 of the traction battery pack 18. The additional cell stacks 22 of the traction battery pack 18 could include a substantially similar design to that shown in FIGS. 3-4.

The battery cells 32 of the cell stack 22 may be arranged between a pair of cross-member assemblies 38. Among other functions, the cross-member assemblies 38 may be configured to hold the battery cells 32 and at least partially delineate the cell stacks 22 from one another within the interior area 30 of the enclosure assembly 24.

Each cross-member assembly 38 may be configured to transfer a load applied to a side of the electrified vehicle 10, for example, for ensuring that the battery cells 32 do not become overcompressed. Each cross-member assembly 38 may be further configured to accommodate tension loads resulting from expansion and retraction of the battery cells 32. The cross-member assemblies 38 described herein are therefore configured to increase the structural integrity of the traction battery pack 18.

A vertically upper side of each cell stack 22 may interface with the enclosure cover 26, and a vertically lower side of each cell stack 22 may interface with a heat exchanger plate 40 that is positioned against a floor of the enclosure tray 28. In another embodiment, the heat exchanger plate 40 may be omitted and the vertically lower side of each cell stack 22 may be received in direct contact with the floor of the enclosure tray 28. Vertical and horizontal, for purposes of this disclosure, are with reference to ground and a general orientation of traction battery pack 18 when installed within the electrified vehicle 10 of FIG. 1.

The cross-member assemblies 38 may be adhesively secured to the enclosure cover 26 and to either the heat exchanger plate 40 or the enclosure tray 28 to seal the interfaces between these neighboring components and to structurally integrate the traction battery pack 18.

The cell stack 22 may be arranged to extend along their respective cell stack axes A between opposing end plates 42. One or more end plates 42 may be positioned between the end of each cell stack 22 and a longitudinally extending side wall 44 of the enclosure tray 28. The end plates 42 may therefore extend along axes that are substantially transverse (e.g. perpendicular) to the cell stack axes A of the cell stacks 22 and the cross-member assemblies 38. In some implementations, the end plates 42 are structural members that span across a majority of the length of the longitudinally extending side wall 44 of the enclosure tray 28 (see FIG. 2). However, other configurations are contemplated within the scope of this disclosure.

FIGS. 3, 4, 5, and 6 illustrate additional details associated with the cross-member assemblies 38 of the traction battery pack 18. Each cross-member assembly 38 may include a ladder frame 46 and one or more reinforcement sections. In the illustrated embodiment, the cross-member assembly 38 includes an upper or first reinforcement beam 48 and a lower or second reinforcement beam 50. However, other configurations are also contemplated within the scope of this disclosure.

The ladder frame 46 may be either a unitary or multi-piece injection molded structure. The ladder frame 46 may be made of any suitable thermoplastic material.

The ladder frame 46 may include one or more vent openings 52 (see FIG. 4) for communicating battery cell vent byproducts released by one or more battery cells 32 through the ladder frame 46 and into a passageway located between adjacent cell stacks 22. The vent openings 52 may therefore provide a pathway for battery cell vent byproducts to move through the cross-member assembly 38 as may be required during a cell venting event of one or more of the battery cell 32 of the cell stack 22, for example.

The ladder frame 46 may additionally include a plurality of cell tab openings 54 (see FIG. 4) arranged vertically below the vent openings 52. The cell tab openings 54 may be elongated slots configured to accommodate cell tab terminals of the battery cells 32. In an embodiment, each cell tab opening 54 may accommodate one cell tab terminal. In another embodiment, each cell tab opening 54 may be sized to receive cell tab terminals from multiple adjacent battery cells 32.

In an assembled state of the cross-member assembly 38, both the vent openings 52 and the cell tab openings 54 are located between the first and second reinforcement beams 48, 50 (see, e.g., FIG. 4). However, other configurations are possible within the scope of this disclosure.

The first reinforcement beam 48 and the second reinforcement beam 50 may be mounted at separate locations of the ladder frame 46 for structurally reinforcing the cross-member assembly 38. The ladder frame 46 and the first and second reinforcement beams 48, 50 may include mateable features that facilitate the connection of the first and second reinforcement beams 48, 50 to the ladder frame 46. For example, the ladder frame 46 may include first engagement features that are configured to mesh or interdigitate with a second engagement feature of the first reinforcement beam 48 or the second reinforcement beam 50. In an embodiment, the first engagement features each include a first arrangement of fingers and slots, and the second engagement features 58 each include a second arrangement of fingers and slots. The fingers of the first engagement features can be received in the slots of the second engagement features 58 and vice versa in order to mount the first and second reinforcement beams 48, 50 to the ladder frame 46. Although not shown, an adhesive could be applied between the first and second engagement features for further facilitating the connection of the first and second reinforcement beams 48, 50 to the ladder frame 46.

In an embodiment, the first and second reinforcement beams 48, 50 are pultrusions, which implicates structure to these beam-like structures. A person of ordinary skill in the art having the benefit of this disclosure would understand how to structurally distinguish a pultruded beam structure from another type of structure, such as an extruded beam, for example.

The first and second first reinforcement beams 48, 50 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the first and second first reinforcement beams 48, 50.

When mounted to the ladder frame 46, the first reinforcement beam 48 may establish an upper plateau 68 of the cross-member assembly 38, and the second reinforcement beam 50 may establish a lower base 70 of the cross-member assembly 38. An adhesive 72 (see FIG. 3) may be applied to the upper plateau 68 and to the lower base 70 for securing the cross-member assembly 38 directly to the enclosure cover 26 and to either the heat exchanger plate 40 or the enclosure tray 28, respectively. Each cell stack 22 may therefore be structurally integrated with the enclosure assembly 24 of the traction battery pack 18 via the cross-member assemblies 38.

Each end of the ladder frame 46 may include one or more fastener housings 74 that are each sized to receive a fastener insert 76. Each fastener insert 76 may be made of a thermoset material, for example, and may be received within an opening provided by the fastener housing 74. In an embodiment, the fastener housings 74 are integrally formed (e.g., molded) features of the ladder frame 46. The first reinforcement beam 48 and the second reinforcement beam 50 may be appropriately shaped to accommodate the fastener housings 74.

Each fastener insert 76 may include a fastener opening 80 that is configured to receive a fastener (e.g., a bolt or screw, not shown) for mounting the cross-member assembly 38 and thus an associated cell stack 22 to a neighboring structure, such as one of the end plates 42, for example. The fastener may be passed through the end plate 42 and can then be accommodated within the fastener opening 80 of the fastener insert 76 for mounting the cell stack 22 to the end plate 42. This connection can help contain tensile loads that can occur over the life of the cell stack 22 as a result of battery cell expansion forces, for example.

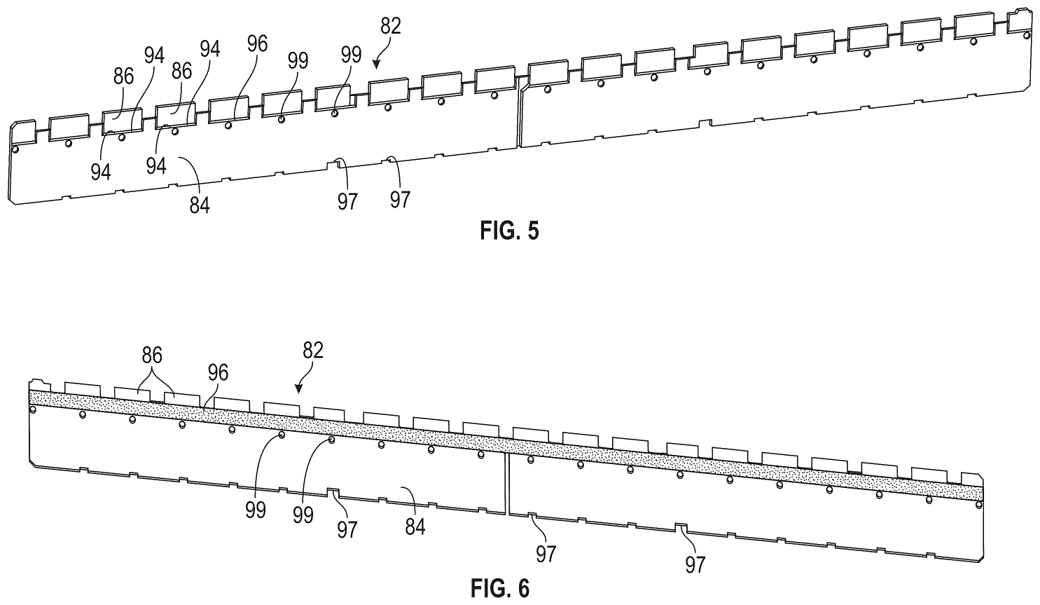

A thermally insulating sheet 82 (shown separate from the cells tack 22 in FIGS. 5 and 6) may be connected to the ladder frame 46 of the cross-member assembly for limiting the transfer of thermal energy from the cell stack 22 to a neighboring structure, such as another cell stack, for example, thereby limiting battery cell vent byproducts and their associated heat from influencing the structural integrity of the traction battery pack 18 during battery thermal events. The thermally insulating sheet 82 may be either a unitary or multi-piece structure made of a flame resistant and heat insulating material. In an embodiment, the thermally insulating sheet 82 is a mica sheet. However, the thermally insulating sheet 82 could be made of aerogel materials, refractory ceramic fibers, or other materials or combinations of materials that are capable of providing flame resistant and heat insulation properties.

The thermally insulating sheet 82 may include a membrane 84 and a plurality of flaps 86 that are each movably connected to the membrane 84 by one or more bridges 94. A pressure sensitive adhesive 96 may mount the thermally insulation sheet 82 to the ladder frame 46 of the cross-member assembly 38. The pressure sensitive adhesive 96 may secure both the membrane 84 and the flaps 86 to the ladder frame 46. In an embodiment, the pressure sensitive adhesive 96 is a double-sided tape. However, other types of adhesive could be utilized within the scope of this disclosure.

The membrane 84 may additionally be positioned and retained relative to the ladder frame 46 by a plurality of stakes 88, a plurality of clips 90, or both. The stakes 88 and the clips 90 may be integrally formed features of the ladder frame 46. In an embodiment, the stakes 88 and the clips 90 may protrude outwardly from sections 92 (see FIG. 4) of the ladder frame 46 that extend between adjacent pairs of the cell tab openings 54. In another embodiment, the clips 90 are provided at a location of the sections 92 that is vertically beneath the stakes 88. However, other configurations are contemplated within the scope of this disclosure.

The stakes 88 may be received through mounting holes 99 that are pre-formed through the membrane 84 for positioning the membrane 84 onto the ladder frame 46. The heads of the stakes 88 may subsequently be deformed, such as via heat staking or cold working, for example, to mount the membrane 84 to the ladder frame 46. The clips 90 may engage notches 97 formed in the membrane 84 for securing the membrane 84 relative to the ladder frame 46.

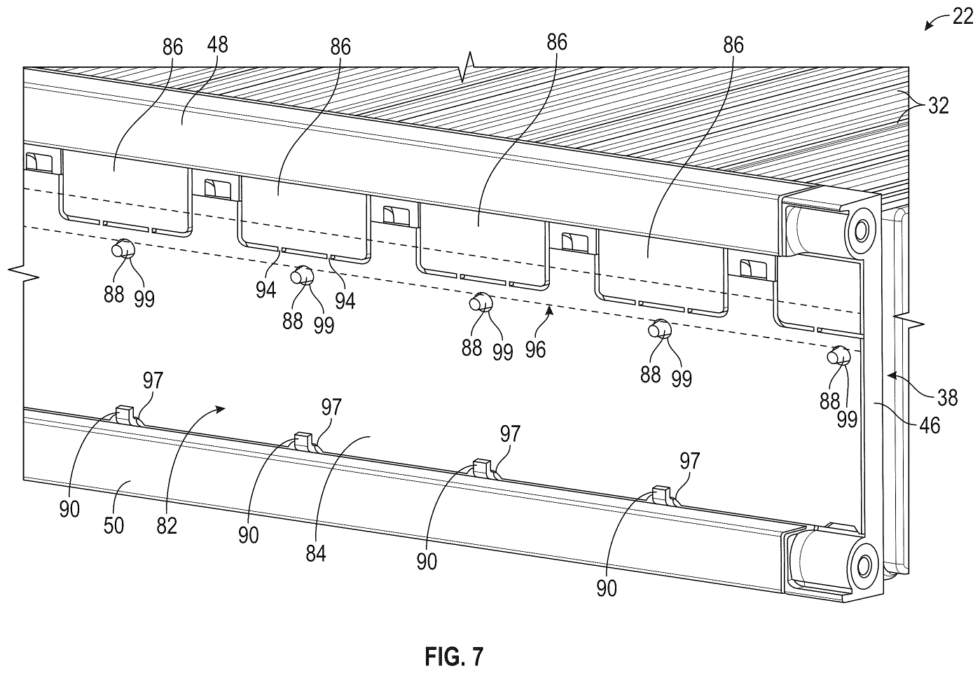

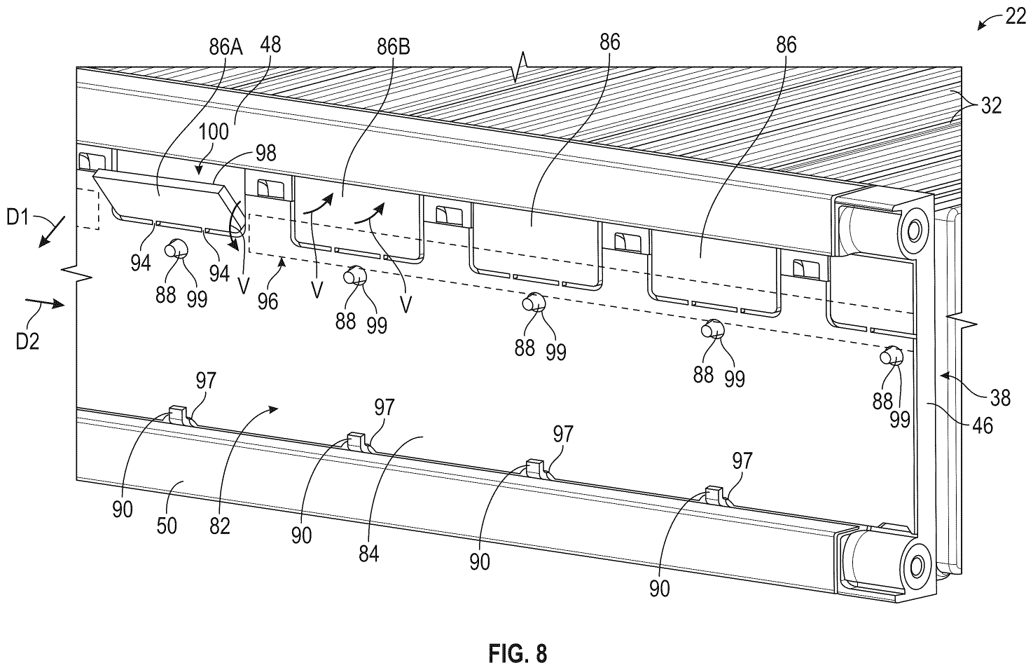

FIGS. 7 and 8 illustrate the thermally insulating sheet 82 of the cross-member assembly 38 during normal operating conditions of the traction battery pack 18 and during a battery thermal event, respectively. During normal operating conditions of the traction battery pack 18 such as schematically shown in FIG. 7, the membrane 84 is positioned to substantially cover the cell tab openings 54 of the ladder frame 46, and the flaps 86 are positioned to substantially cover the vent openings 52 of the ladder frame 46. The thermally insulating sheet 82 is therefore configured to block the transfer of thermal energy from the cell stack 22 to an adjacent cell stack or other battery internal structure of the traction battery pack 18.

During a battery thermal event such as schematically shown in FIG. 8, one or more of the battery cells 32 can rupture and release battery cell vent byproducts V. Although a single one of the battery cells 32 is shown as venting in FIG. 5, more than one of the battery cells 32 can vent at the same time. The battery cell vent byproducts V may flow through one of the vent openings 52 and then against the thermally insulating sheet 82. The battery cell vent byproducts V can move against a backside 98 of one of the flaps 86A during the battery thermal event, thereby displacing the flap 86A to permit flow of the battery cell vent byproducts V through an exposed opening 100 of the thermally insulating sheet 82. The backside 98 of each flap 86 faces toward the battery cells 32 of the cell stack 22. The flap 86 may rotate about the bridges 94 to move to the open position relative to the membrane 84.

In an embodiment, when a flow of the battery cell vent byproducts V moves against the backside 98 of the flap 86, a temperature associated with the battery cell vent byproducts V may exceed a predefined temperature threshold that causes the pressure sensitive adhesive 96 to melt and thus allow the flap 86A to move from the closed position of FIG. 7 to the open position of FIG. 8. Each flap 86 of the thermally insulating sheet 82 is therefore configured to move from the closed position to the open position in response to a flow of the battery cell vent byproducts V against the flap 86. The flaps 86 are therefore configured to act as thermal control valves for controlling the flow of battery cell vent byproducts V during battery thermal events of the traction battery pack 18.

The battery cell vent byproducts V may flow through the vent opening 52 of the ladder frame 46 before contacting the backside 98 of the flap 86A. This contact can redirect the battery cell vent byproducts V. In particular, the battery cell vent byproducts V can initially move in a first direction D1. After contacting the backside 98 of the flap 86, the battery cell vent byproducts V can be redirected to flow in a second direction D2 that is different than the first direction D1. Battery cell vent byproducts V moving in the second direction D2 are moving, in this example, toward an adjacent flap 86B of the thermally insulating sheet 82. Motive forces associated with the battery cell vent byproducts V may be sufficient to maintain the adjacent flap 86B in the closed position relative to the membrane 84, thereby preventing the battery cell vent byproducts V from passing back into the cell stack 22.

The exemplary cross-member assemblies of this disclosure include a thermally insulating sheet for blocking the transfer of thermal energy from cell stack-to-cell stack within a traction battery pack. The thermally insulating sheet incorporates thermal control valves in the form of movable flaps for controlling the flow of battery cell vent byproducts during battery thermal events.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a cell stack including a plurality of battery cells arranged between a first cross-member assembly and a second cross-member assembly; and
the first cross-member assembly and the second cross-member assembly each including a ladder frame and a thermally insulating sheet mounted to the ladder frame.

2. The traction battery pack as recited in claim 1, wherein the ladder frame is comprised of a thermoplastic material and includes a plurality of cell tab openings each sized to receive a terminal of one or more of the plurality of battery cells.

3. The traction battery pack as recited in claim 1, wherein the ladder frame includes a vent opening.

4. The traction battery pack as recited in claim 3, wherein the thermally insulating sheet includes a flap that is movable between a first position that covers the vent opening and a second position that uncovers the vent opening in response to a flow of a battery cell vent byproduct against the flap.

5. The traction battery pack as recited in claim 4, wherein the flap is movably connected to a membrane of the thermally insulating sheet by at least one bridge.

6. The traction battery pack as recited in claim 5, wherein the ladder frame includes a stake that is received through a mounting hole of the membrane to position the membrane relative to the ladder frame.

7. The traction battery pack as recited in claim 5, wherein the ladder frame includes a clip that holds the membrane relative to the ladder frame.

8. The traction battery pack as recited in claim 4, wherein the flap is held in the first position by a pressure sensitive adhesive.

9. The traction battery pack as recited in claim 8, wherein the pressure sensitive adhesive is configured to melt when a temperature of the battery cell vent byproduct exceeds a predefined temperature threshold to allow the flap to move to the second position.

10. The traction battery pack as recited in claim 1, wherein the ladder frame includes an integrally formed fastener housing.

11. The traction battery pack as recited in claim 10, comprising a fastener insert received within the integrally formed fastener housing and configured to receive a fastener.

12. The traction battery pack as recited in claim 1, comprising a pultruded reinforcement beam attached to the ladder frame.

13. A traction battery pack, comprising:
a cross-member assembly including:
a ladder frame;
a first reinforcement beam mounted to the ladder frame;
a second reinforcement beam mounted to the ladder frame; and
a thermally insulating sheet mounted to the ladder frame and including a membrane and a plurality of flaps movably connected to the membrane.

14. The traction battery pack as recited in claim 13, wherein the first reinforcement beam establishes a first pultrusion of the cross-member assembly, and the second reinforcement beam establishes a second pultrusion of the cross-member assembly.

15. The traction battery pack as recited in claim 13, wherein the first reinforcement beam establishes an upper plateau of the cross-member assembly, and the second reinforcement beam establishes a lower base of the cross-member assembly.

16. The traction battery pack as recited in claim 15, comprising an adhesive applied to the upper plateau and to the lower base.

17. The traction battery pack as recited in claim 13, comprising a first fastener insert received within a first fastener housing of the ladder frame, and a second fastener insert received within a second fastener housing of the ladder frame.

18. The traction battery pack as recited in claim 13, wherein each of the plurality of flaps is movable between a first position that covers a respective vent opening of the ladder frame and a second position that uncovers the respective vent opening in response to a flow of a battery cell vent byproduct against the thermally insulating sheet.

19. The traction battery pack as recited in claim 13, wherein the ladder frame includes a stake that is received through a mounting hole of the membrane to position the membrane relative to the ladder frame.

20. The traction battery pack as recited in claim 13, wherein the ladder frame includes a clip that engages a notch of the membrane to secure the membrane relative to the ladder frame.
